(19) United States
(12) Patent Application Publication
(10) Pub. No.: US 2010/0277335 A1
(43) Pub. Date: Nov. 4, 2010

(54) Presentation of Visual Information

(76) Inventors: Kaj Makela, Helsinki (FI); Zoran Radivojevic, Cambridgeshire (GB)

Correspondence Address: HARRINGTON & SMITH, 4 RESEARCH DRIVE, Suite 202, SHELTON, CT, 06484-6212, US

(21) Appl. No.: 12/681,423

(22) PCT Filed: Oct. 5, 2007
(86) PCT No.: PCT/EP07/60609

§ 371 Date: Jul. 2, 2010

(51) Int. Cl. G08B 5/00; G06K 19/067

(52) U.S. Cl. 340/815.4; 235/492

(57) ABSTRACT

A method includes capturing at a first device electrical energy of electromagnetic waves transmitted by a second device. The method further includes using the captured electrical energy for causing a modification of a visual appearance of a display component. In addition to the wireless power, the visual appearance may depend on a data transmission.

### FIELD OF THE INVENTION

The invention relates in general to the presentation of visual information.

### BACKGROUND OF THE INVENTION

Still images and graphical motifs are used as signs, signals and cues in the environment to instruct people and to provide information. Iconic language, for example, helps users intuitively to react adequately in different situations or to receive simplistic but very useful information independently of spoken language. Still images and graphical motifs are thus suited to make information and instructions more nationality-independent and universal (even for illiterates).

### SUMMARY

The invention proceeds from the consideration that the description of dynamic or serial information by means of a static image or pattern may be difficult. The description of a sequential procedure, for example, requires a sub-image or sub-pattern for each step. This requires space for the presentation and moreover cognitive efforts from the user to recognize the order of the sub-images, to understand the meaning of each sub-image and to associate to each sub-image an action that is required to operate and/or interact with a device. Also a presentation of other kinds of causalities may require complex illustrations.

Studies on the interaction with physical tags have shown that users lacking prior knowledge of the exact way of interacting with tags require sufficient information in order to form a mental model for the interaction (cf. K. Mäkeläet al: “Mobile interaction with visual and RFID tags: a field study on user perceptions”, Proceedings of the SIGCHI conference on Human factors in computing systems, San Jose, Calif., USA. Pages: 991-994, Year of Publication: 2007, ISBN:978-1-59593-593-9). Static visual icons might not be able to provide sufficient cues for the interaction.

Static images or patterns are moreover suited only to a limited extent to capture the attention of a user. The only way of attracting a user's attention with static images is spatial distinguishability, for example using bright colors and textural differences related to the background. The human contemplation and observing process, however, is largely based on noting dynamic, temporal changes in the surrounding environment. Therefore, the attention of people is directed by detected changes in the environment, which cannot be realized with a static image.

A method is described, which comprises capturing at a first device electrical energy of electromagnetic (EM) waves transmitted by a second device. The method further comprises using the captured electrical energy for causing a modification of a visual appearance of a display component.

Moreover, an apparatus is described, which comprises an antenna or antenna system configured to capture electrical energy of electromagnetic waves. The apparatus further comprises an electrical circuit configured to use the captured electrical energy for causing a modification of the visual appearance of a display component.

Moreover, a system is described, which comprises the described apparatus and in addition an apparatus configured to emit electromagnetic waves.

Finally, an apparatus is described, which comprises in general means for capturing electrical energy of electromagnetic waves transmitted by another apparatus; and means for using the captured electrical energy for causing a modification of a visual appearance of display means.

A presented image or pattern can be altered, if such an alteration is supported by the component presenting the image or pattern. A display component has usually to be supplied with electrical power for being able to alter a presentation. It is proposed that energy delivered by electromagnetic waves is used for acting on a display component to this end. This can be realized in different ways. In one alternative, for example, the display component does not have an own power source, and the captured electrical energy can be applied to the display component for powering the display component. If the display component is a low power component, a small amount of energy is sufficient for modifying a presentation and thus the visual appearance of the display component. In another alternative, the display component could have its own power source. The energy could then be used for triggering a circuit that acts as a switch for the display component.

The described approach provides a possibility of presenting animated information at low costs. A changing visual appearance of a display component allows capturing the attention of a user. Further, it allows conveying more information to a user than a single still image. This increases the usage commodity, for example for instructive steps and suggestions or information on provided service or a function a tag is related to. Since power is obtained from received electromagnetic waves, the apparatus is moreover not required to have an own power source, even though it could have an own power source.

The modification of the visual appearance can be caused in particular as an immediate response to a capture of electrical energy.

In an exemplary embodiment, the modification of the visual appearance is only carried out if a user brings the device emitting the electromagnetic waves sufficiently close to the display component (proximity interaction). This can be realized for instance by setting a threshold value for the captured energy that has to be reached before a modification is caused. With this approach, for example a causal relation between a user's proximity to the display component and a possible interaction may be visualized.

In addition to the proximity between a device emitting the electromagnetic waves and the display component, also the orientation between the devices and the display component could be considered. For example, electrical energy of electromagnetic waves transmitted by a device could be captured and used for modifying the visual appearance of the display component only, in case the electromagnetic waves have a predetermined orientation relative to the display component. The antenna of an apparatus may be designed to this end to be a directional antenna, which captures electrical energy of electromagnetic waves having a predetermined orientation relative to the antenna only.

Also more complex situations could be detected as a condition for a modification of a presentation, for instance that a user performs a predetermined movement with a device comprising the display component when brought in proximity to another device which is emitting the electromagnetic waves, or that a user performs a predetermined movement with the device emitting the electromagnetic waves relative to and in proximity to the display component.

In another exemplary embodiment, the first device may receive in addition data from the second device and modify the visual appearance of the display component in accordance with the received data.

An apparatus may comprise to this end an antenna which is configured to receive the data and a processing component configured to cause a modification of the visual appearance of the display component in accordance with the received data. The antenna for receiving data may be an additional antenna or antenna system, but it could also be the same antenna or antenna system as used for capturing energy from electromagnetic waves. The processing component can be implemented in hardware and/or software. It may be for instance a processor executing computer program code for realizing the required functions. A corresponding computer program product could store the computer program code in a computer readable medium. Such a computer program product could be for example a separate memory device, or a memory that is to be integrated in the apparatus.

The data could be modulated for example onto the electromagnetic waves.

The received data could be exploited in several ways for modifying the visual appearance of the display component. In one exemplary embodiment, the received data could be used for changing the visual appearance only if the received data comprises a predetermined component, for example a component which is equal to a stored identifier. In another exemplary embodiment, several options could be predefined for the visual appearance. An indication in the received data can then be used as a criterion for selecting one of the predefined options for modifying the visual appearance of the display component. In another exemplary embodiment, the received data could freely define the visual appearance that is to be used. It is to be understood that these embodiments could also be used in combination.

The electromagnetic waves could further be caused by any suitable type of radio transmission and in different radiofrequency ranges and standards, such as: Bluetooth™, ultra wide band (UWB), Wibree, radio frequency identification (RFID), or just inductive coupling techniques and transmission frequencies as used for WiFi® or the Global System for Mobile Communications (GSM), etc. It is to be understood that this list of examples is by no means exhaustive. Depending on the supported transmission technique, a threshold value could be selected such that the captured electrical energy is only used for a modification of the visual appearance of a display component in case the device emitting the electromagnetic waves is within a predetermined range from the display device.

In the case of RFID, it would also be possible to use the same technology for both reading an RFID of an RFID tag, for example by means of an RF-reader, and changing the visual appearance of a display component of the RFID tag in a parasitic manner utilizing the energy employed for the query.

The modification of the visual appearance of a display component can be implemented in various ways. It could comprise for example initiating a presentation. That is, an image, graphical icon, soft key identifier or pattern appears only when energy is applied. Alternatively, it could comprise for example switching off a presentation. That is, a displayed image or pattern disappears when energy is applied. Further alternatively, a presented image or pattern could change its form when energy is applied, etc. Changing a presentation may mean replacing a current presentation by a completely different presentation or modifying a current presentation, for instance by adding/removing selected elements or by creating the impression that a presented object moved. An example might be a manikin, which is presented both before and after the modification of the visual appearance, but which points only after the modification of the visual appearance in a desired direction.

The visual appearance of the display component resulting from a modification could further be temporary or permanent until a next modification occurs. A temporary modification can be realized by means of a non-stable display material, electro active process or display element, while a permanent modification can be realized by means of a bi-stable display material or display element.

The described apparatus may comprise various additional components, for instance the display component. It could further be a device or a part of a device.

One example for the apparatus comprising the display component is a smart card, which is enhanced with a graphical effect.

The display component may use ultra low power consumption display technologies, such as a liquid crystal display (LCD), an active pigment material, an electro-chromic display, an electro-phoretic display, a cholesteric display, an electronic ink display or electronic paper, etc. Electronic paper, for instance, could be in the form of a flexible plastic film which is made of polymer-networked liquid crystal (PNLC) material or some other suitable material. The display component could also simply comprise one or more light emitting diodes (LED), which could be switched on when the emitter is in proximity, the visual change indicating an activity/location.

In general, the display component may be any type of display component which enables a change of its visual appearance when power is supplied, in particular though not exclusively a display component which makes use of any low power consumption non-stable or bi-stable display technology. In an exemplary embodiment, however, the display component enables specifically a presentation of informative content, not just catching the attention of a user, as in the case of a single LED.

The approach according to the invention can be used for various use cases. Exemplary use cases include providing interaction cues helping interaction with smart environments, displaying sequential or causal information, catching a user's attention in the environment or indicating active elements and associated services in the environment. Exemplary use cases further include animating an icon using a non-stable display component to provide interaction instructions with a two-frame animation, or instructing a serial two-step procedure using a bi-stable display component, for example “first touch this, then press button”. Exemplary use cases further include showing information related to a target to which information in an RFID tag points. Exemplary use cases further include a device with a light weight audio component, like a playing greetings card. In this case, the battery for the audio component could also be used for the display component, while the captured electrical energy only switches a display circuit.

It is to be understood that the features of all presented exemplary embodiments may be used in any suitable combination.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram illustrating of a first embodiment of the invention;

FIG. 2 is a schematic diagram illustrating a second embodiment of the invention; and

FIG. 3 is a flow chart illustrating an operation in the system of FIG. 2.

### DETAILED DESCRIPTION OF THE INVENTION

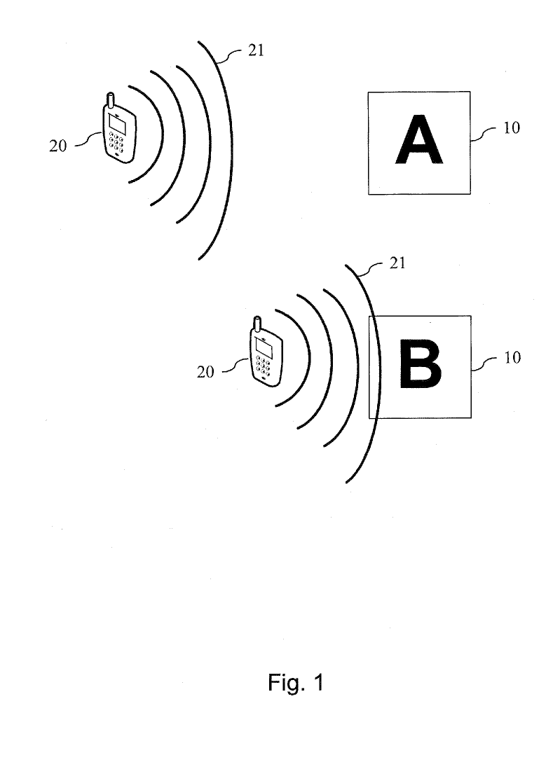

FIG. 1 illustrates the principle of a first exemplary embodiment of the invention, in which a presentation by a passive device is modified.

In a first situation presented in the upper part of FIG. 1, a passive device 10 comprising a display component is located at a distance to another device 20. Device 10 could be for instance a smart card, while device 20 could be for instance a mobile phone in which a transmission in a predefined frequency range might have been activated. The predefined frequency range could be for example a frequency range defined for Bluetooth™, Wibree, UWB or RFID, but equally any other short range radio technique transmission. Even if device 20 emits electromagnetic waves 21 in the predetermined frequency range, the energy reaching device 10 is very low. In this situation, the display component of device 10 presents a first pattern “A”.

In a second situation presented in the lower part of FIG. 1, device 20 which emits electromagnetic waves 21 in the predefined frequency range and has approached device 10. Device 10 captures the energy in the electromagnetic waves 21 and uses the energy for a power supply of the display component. The power supply is used for changing the pattern presented by the display component from “A” to “B”.

The display component of device 10 could be for example non-stable. That is, it returns to pattern “A” again, when device 20 is removed from the proximity of device 10 so that device 10 is no longer able to supply energy to its display component. Either pattern “A” or pattern “B” could also be blank. Further, pattern “B” could present the same motif as pattern “A”, just in a changed form. Further, patterns “A” and “B” could be completely different from each other.

In case a bi-stable display technology is used instead for the display component 10, the pattern “B” remains stable even after device 10 is getting away from the device 20 or after switching off the wireless power transmission at the device 20.

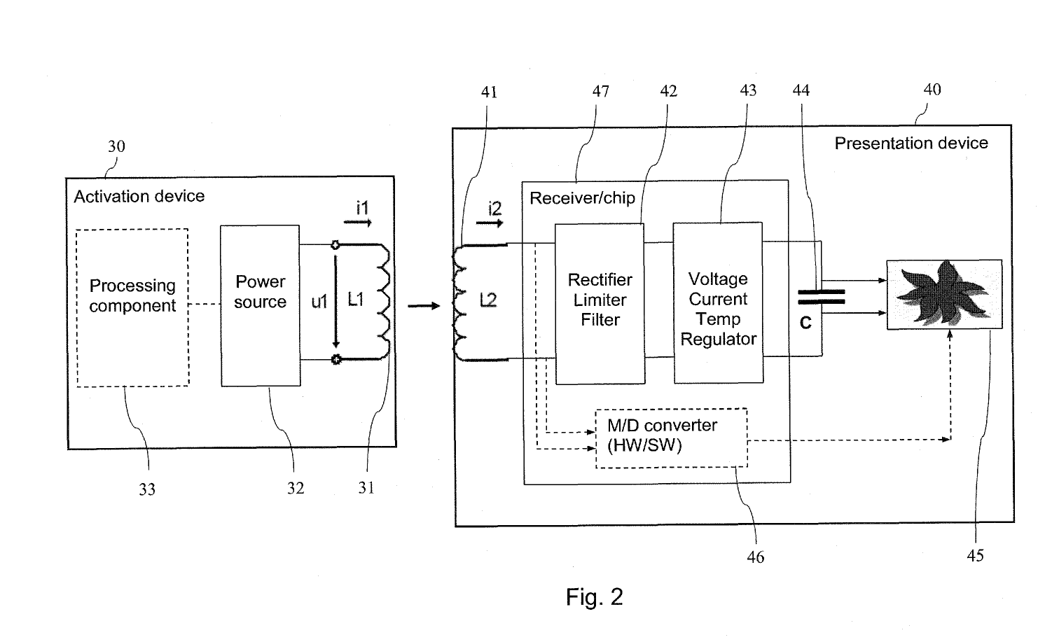

FIG. 2 is a schematic diagram illustrating another exemplary embodiment of the invention, in which a presentation by a passive device is modified. The system comprises a basic implementation and an enhanced implementation. Components and connections for the enhanced implementation are indicated with dashed lines.

FIG. 2 presents a system, which comprises an activation device 30 and a presentation device 40.

Activation device 30 can be any device that is configured to emit electromagnetic waves. Activation device 30 may comprise to this end an antenna 21 including a coil L1. The coil 31 is linked to a power source block 32 including a power control. Optionally, activation device 30 could comprise in addition a processing component 33 which is linked to the power source block 32.

Activation device 30 could be for example a mobile phone supporting Bluetooth™, Wibree, UWB or an RFID reader, etc.

Presentation device 40 is a passive device, that is, it does not comprise an own power source.

Presentation device 40 comprises an antenna 41 including a coil L2. The antenna 41 is linked via a block 42 including rectifier, limiter and filter components and via a block 43 including a regulator to the connection points of a capacitor (C) 44. The output of the capacitor 44 is connected to a power input of a low-power bi-stable display component 45. The display component 45 may have for example a switching speed of 10 ms at 2.5 V operating voltage and an average power consumption of 4 μW for a display having a size of 20 cm². The display could be realized for instance by means of a flexible plastic film or electronic paper, etc.

Optionally, the antenna 41 may be connected in addition via a modulation-to-digital converter (M/D) 46 to a control input of the display component 45. The M/D converter 46 may be implemented in hardware and/or software. It may comprise for instance a modulation/demodulation circuitry and a processor executing computer program code that is read from a computer readable medium, like a memory (not shown).

Some of the components of presentation device 40 may be implemented for example on a chip 46. Receiver components 42, 43 and 44 could belong for instance to an integrated circuit on a chip 46.

Presentation device 40 or parts of presentation device 40 may correspond to an apparatus according to the invention. Blocks 42, 43 and capacitor 44 may correspond to an electrical circuit according to the invention. Block 43 may realize in addition a determination component according to the invention. M/D converter 46 may correspond to a processing component according to the invention.

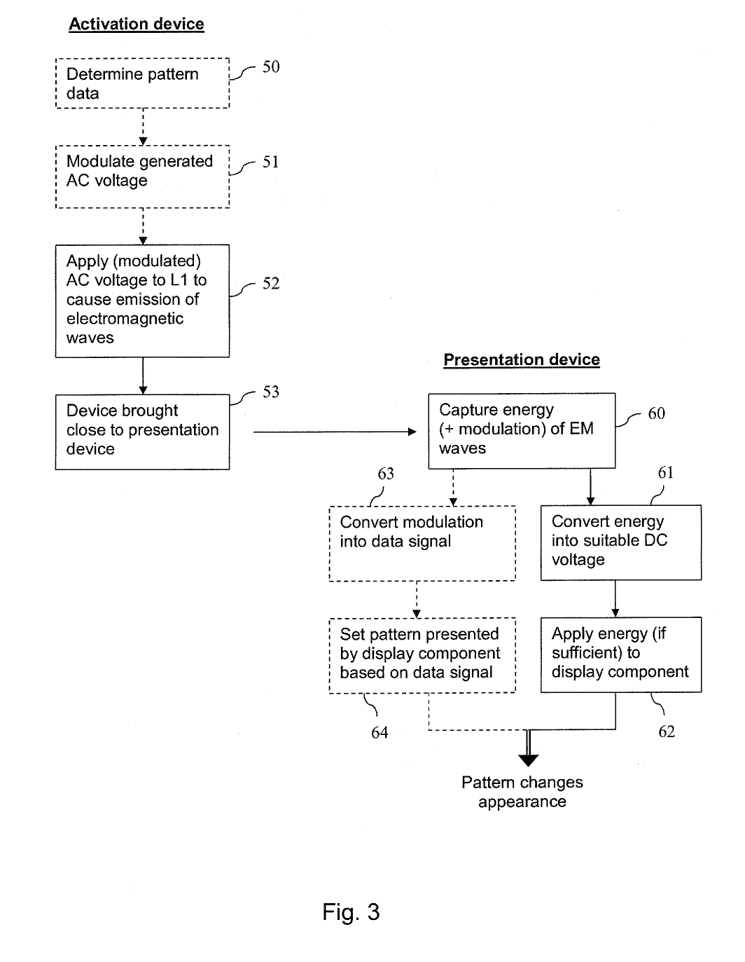

An operation in the system of FIG. 2 will now be explained in more detail with reference to the flow chart of FIG. 3. Steps for the enhanced implementation are indicated with dashed lines.

In activation device 30, the processing component 33 may determine data representing a pattern that is to be presented by display component 45 (step 50). The data may comprise for example the entire image data required for the presentation of the pattern or only a code identifying one of at least two predetermined patterns. In the latter case, the code may also be determined by some characteristic of activation device 30 or of the user of activation device 30, in accordance with subscribed service, etc.

The data may be used by the processing component 33 for causing a modulation of an alternating (AC) voltage u1 that is generated by power source block 32 (step 51). The modulation is performed with a low data rate.

Alternatively, the power source 32 could simply provide a generated alternating voltage u1 at its output.

The optionally modulated alternating voltage u1 is impressed on antenna 31 (step 52). The resulting alternating current i1 in coil L1 causes an emission of an electromagnetic wave.

When activation device 30 is in proximity to presentation device 40 (step 53), the emitted electromagnetic wave induces an alternating current i2 and thus energy in coil L2 of antenna 41 (step 60).

The alternating current i2 is fed to and processed by block 42. More specifically, the alternating current i2 may be rectified to obtain a direct (DC) current, limited to a predetermined value to avoid a damage of display component 45, and filtered to remove remaining alternating components.

The resulting direct current is fed to and further processed by block 43 for obtaining a suitable direct voltage. Block 43 connects a resulting direct voltage to capacitor 44, if it can be ensured that capacitor 44 will maintain a sufficiently high voltage for a sufficient period of time. This is the case, if activation device 30 is close enough to presentation device 40 relative to the used transmission energy for some time, and if coil L1 of antenna 31 and coil L2 of antenna 41 are aligned. The required maximum distance between activation device 30 and presentation device 40 in the case of aligned coils L1, L2 may lie for example between a couple of centimeters and a couple of meters, depending on the power of the emitted electromagnetic waves and on the power required for operating display component 45. It is to be understood that the threshold value for the available energy may be set higher than required for powering the display component 45, if it is to be ensured that display component 45 is only to be powered in case activation device 30 is sufficiently close to presentation device 40.

Furthermore physical alignment between the coils L1 and L2 could be used to extract information about a relative angle between the devices 30 and 40, and this information could be utilized as a guiding parameter for instruction and services to the user and for his interaction with the overall system.

The voltage across capacitor 44, if any, has a constant, predetermined value as required for the operation display component 45 (step 61). In the present example, the voltage has a value of 2.5 V and is available for at least 10 ms.

It is to be understood that the described processing order can be changed, that some processing steps may be omitted and that other processing steps may be added.

The voltage across capacitor 44 is supplied to the power input of display component 45 (step 62).

When power is supplied to the display component 45, the previously presented pattern is modified. The new pattern may be predefined or be defined by data applied to the control input of the display component 45.

In case the electromagnetic radiation emitted by activation device 30 is modulated with data for the pattern (see step 51), also the alternating current i2 induced into coil L2 is modulated with this data.

The M/D converter 46 detects this modulation in alternating current i2 and converts the modulation back into data (step 63).

In case the data obtained in the M/D converter 46 comprises only an indication of a selection of a predefined pattern, the M/D converter 46 may provide this indication to display component 45 (step 64). The display component 45 may comprise in this case a selection component (not shown), which causes a presentation of one of a plurality of predefined patterns. The predefined patterns may be hardcoded in a switchable manner or they may be defined by data that is retrieved from a memory (not shown) of the display component 45 when selected and used for adapting a presentation.

In case the data obtained in the M/D converter 46 comprises the complete data for a desired pattern, the data may be directly usable for a control of display component 45, or the M/D converter 46 may be configured in addition to generate control data for controlling the display component 45 based on the received data to present the desired pattern (step 64).

The power that is required by the M/D converter 46 for its operation may be extracted from a portion of current i2 by the M/D converter 46. Alternatively, the required power supply could be provided as well by block 43.

Due to the bi-stable character of the display component 45, the new pattern is maintained, even if power is no longer applied to the display component 45.

If the activation device 30 is not approached sufficiently or for a sufficient time to the presentation device 40 as required in step 53, the emission of the electromagnetic radiation by activation device 30 has no effect on the presentation of the display component 45 of presentation device 40.

The functions illustrated by the antenna 41 can be viewed as means for capturing electrical energy of electromagnetic waves transmitted by another apparatus, while blocks 42, 43 and capacitor 44 can be viewed as means for applying the captured electrical energy to display means for causing a modification of a visual appearance of the display means. The display component 45, finally, can be viewed as such display means.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

1. A method comprising: capturing at a first device electrical energy of electromagnetic waves transmitted by a second device; and using the captured electrical energy for causing a modification of a visual appearance of a display component.

2. The method according to claim 1, further comprising determining whether the captured electrical energy exceeds a predetermined threshold and using the captured electrical energy for causing a modification of a visual appearance of the display component only in case it is determined that the captured electrical energy exceeds a predetermined threshold.

3. The method according to claim 1, wherein electrical energy of electromagnetic waves transmitted by a second device is captured and used for causing a modification of a visual appearance of the display component only in case the electromagnetic waves have a predetermined orientation relative to the first device.

4. The method according to claim 1, further comprising at the first device receiving data from the second device and modifying the visual appearance of the display component in accordance with the received data.

5. (canceled)

6. The method according to claim 4, wherein causing a modification of the visual appearance of the display component in accordance with the received data comprises causing a modification of the visual appearance of the display component only in case the received data comprises a predefined data component.

7. The method according to claim 4, wherein causing a modification of the visual appearance of the display component in accordance with the received data comprises selecting based on an indication in the received data one of a plurality of predefined options for modifying the visual appearance of the display component.

8. (canceled)

9. The method according to claim 1, wherein a modification of the visual appearance of the display component comprises one of: initiating a presentation; switching off a presentation; and changing a presentation.

10. The method according to claim 1, wherein a modification of the visual appearance of the display component comprises one of: modifying a presentation temporarily; of modifying the presentation permanently until a next modification occurs.

11. An apparatus comprising: an antenna configured to capture electrical energy of electromagnetic waves; and an electrical circuit configured to use the captured electrical energy for causing a modification of the visual appearance of a display component.

12. The apparatus according to claim 11, further comprising a determination component configured to determine whether the captured electrical energy exceeds a predetermined threshold, the electrical circuit being configured to use the captured electrical energy for causing a modification of the visual appearance of the display component only in case it is determined that the captured electrical energy exceeds a predetermined threshold.

13. The apparatus according to claim 11, wherein the antenna is a directional antenna.

14. The apparatus according to claim 11, further comprising an antenna which is configured to receive data from the second device and a processing component configured to cause a modification of the visual appearance of the display component in accordance with the received data.

15. (canceled)

16. The apparatus according to claim 14, wherein causing a modification of the visual appearance of the display component in accordance with the received data comprises causing a modification of the visual appearance of the display component only in case the received data comprises a predefined data component.

17. The apparatus according to claim 14, wherein causing a modification of the visual appearance of the display component in accordance with the received data comprises selecting based on an indication in the received data one of a plurality of predefined options for modifying the visual appearance of the display component.

18. (canceled)

19. The apparatus according to claim 11, further comprising the display component.

20. The apparatus according to claim 19, wherein the display component is configured to enable a modification of the visual appearance of the display component by one of: initiating a presentation; switching off a presentation; and changing a presentation.

21. The apparatus according to claim 19, wherein the display component is configured to be one of: bi-stable; of non-stable.

22. The apparatus according to claim 19, wherein the display component comprises one of: an active pigment material; an electro-chromic display; an electro-phoretic display; a cholesteric display; an electronic ink display; or an electronic paper.

23. The apparatus according to claim 19, wherein the apparatus is a smart card.

24. (canceled)

25. An apparatus comprising:
means for capturing electrical energy of electromagnetic waves transmitted by a device; and means for using the captured electrical energy for causing a modification of a visual appearance of display means.
